(19) United States
(12) Patent Application Publication
(10) Pub. No.: US 2021/0122148 A1
(43) Pub. Date: Apr. 29, 2021

(54) MULTILAYER SYNTHETIC BOARD STOCK

(71) Applicant: PROFOL AMERICAS, INCORPORATED, Cedar Rapids, IA (US)

(72) Inventors: Mark VanSUMEREN, Midland, MI (US); Justin Young, Cedar Rapids, IA (US); Thomas Fritz, Casper, WY (US)

(73) Assignee: PROFOL AMERICAS, INCORPORATED, Cedar Rapids, IA (US)

(21) Appl. No.: 17/078,458

(22) Filed: Oct. 23, 2020

Related U.S. Application Data
(60) Provisional application No. 62/924,993, filed on Oct. 23, 2019.

(51) Int. Cl. B32B 27/08; B32B 27/32; B32B 27/20; B29C 48/07; B29C 48/21; B29C 48/00

(52) U.S. Cl. CPC B32B 27/08; B32B 27/32; B32B 27/20; B29C 48/07; B29C 48/21; B32B 2323/10; B32B 2250/03; B32B 2250/24; B32B 2307/21; B32B 2307/72; B32B 2439/70; B29C 48/022

(57) ABSTRACT

A synthetic board stock for packaging food product is described, as well as a process for producing the synthetic board stock. The synthetic board stock has multiple layers with chosen properties. The board stock has a density less than 1.0 g/cm3 in order to meet the post-consumer waste stream recycling requirements for polypropylene, polyethylene and other polyolefin polymers. A process for making the synthetic board stock is also described, wherein the process eliminates a step from the prior related to dual print passes.

### CROSS-REFERENCE TO RELATED APPLICATIONS

The present application claims priority to provisional patent application 62/924,993 which was filed on Oct. 23, 2019, and is hereby expressly incorporated by reference in its entirety.

### BACKGROUND OF THE INVENTION

The conventional method for producing synthetic board stock utilized in the food industry produces a synthetic board stock that does not meet certain standards allowing it to be recyclable in traditional water sink float separation methods used in the recycle industry for polypropylene and polyethylene. Additionally, the conventional method utilizes a separate step of applying a printing ink to a particular surface of the synthetic board stock.

Therefore, it is an object of the invention to produce a synthetic board stock that meets the recycling requirements of post-consumer waste stream for polyolefins.

It is a further object of the invention to make a method for producing synthetic board stock eliminating the need for applying printing ink to more than one surface, thereby eliminating a costly second printing pass.

### SUMMARY OF THE INVENTION

The synthetic board stock has multiple layers with chosen properties. The board stock has a density less than 1.0 g/cm3 in order to meet the post-consumer waste stream recycling requirements for polypropylene, polyethylene and other polyolefin polymers.

### BRIEF DESCRIPTION OF THE DRAWINGS

FIG. 1 is a front view of a cross-section of the board showing the three distinct layers.

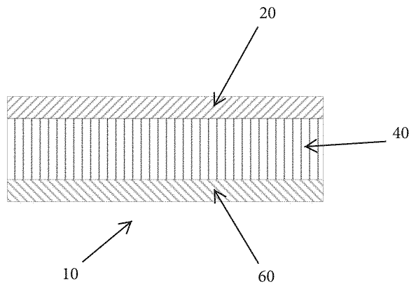

### DETAILED DESCRIPTION OF THE INVENTION

Now referring to the FIGURE, a synthetic board stock 10 is produced via a cast film multilayer coextrusion process. The synthetic board stock 10 is comprised of three layers.

The synthetic board stock is preferably made by the following method. The raw materials (resins, additives, colors, etc.) for a particular layer are first gravimetrically weighed and blended in the solid state. The blended raw materials are vacuum conveyed to one of three independent single screw extruders where the materials are melted and mixed. Additional layers with different compositions are conveyed to the other two screw extruders. The melt streams are combined in a coextrusion block and they flow through a coat hanger die. The melt exits the die and the synthetic board stock 10 is formed on the chill roll. The synthetic board stock 10 then moves through a series of driven and non-driven rollers.

The synthetic board stock 10 passes between a thickness gauge that measures the thickness profile across the web. The thickness gauge relays thickness feedback to the die, which automatically adjusts for thickness deviations. The synthetic board stock 10 is then passed through a series of rollers at elevated temperature designed to anneal the board stock to relax internal stress in the synthetic board stock 10. Following the annealing station, the synthetic board stock 10 is corona treated for printability. Finally, the web is trimmed to the final desired width before being wound into the finished roll form.

An outer layer 20 of the synthetic board stock 10 is preferably comprised of polypropylene (melting point 160-165° C.), inorganic fillers (including talc and calcium carbonate), and colorant. This is the corona treated layer for printing.

A center layer 40 of the synthetic board stock 10 is preferably comprised of a blend of polypropylene resins (melting point 160-165° C.) and a hydrocarbon resin. The hydrocarbon resin functions to increase the stiffness of the synthetic board stock 10 for easy die cutting and dead fold of the synthetic board stock 10. In addition, the use of this additive allows the synthetic board stock 10 to have a density less than 1.0 g/cm3 as compared to other common methods to increase board stiffness. In-process trim scrap is reclaimed and is fed into the center layer 40.

An inner layer 60 of the synthetic board stock 10 is preferably comprised of a blend of polypropylene resins (melting point 160-165° C.), an antistatic additive to improve sheet handling at the printer, and a custom color that is not printed. Alternatively, the inner layer 60 could be equivalent to the outer layer 20 for two-sided print jobs.

In the preferred embodiment, the outer layer 20 comprises fifteen percent of the overall synthetic board stock; the center layer 40 comprises seventy percent of the overall synthetic board stock; and the inner layer 60 comprises fifteen percent of the overall synthetic board stock.

The three layer composition as described is preferred, but could be more or less than three layers depending upon extruder and feedblock configuration. Also, the layers 20, 40 and 60 can all be the same composition or different than described above.

Having thus described the invention in connection with the several embodiments thereof, it will be evident to those skilled in the art that various revisions can be made to the several embodiments described herein without departing from the spirit and scope of the invention. It is my intention, however, that all such revisions and modifications that are evident to those skilled in the art will be included with in the scope of the following claims. Any elements of any embodiments disclosed herein can be used in combination with any elements of other embodiments disclosed herein in any manner to create different embodiments.

What is claimed is:

1. A synthetic board stock for packaging food, comprising:
an outer layer;
a center layer;
an inner layer;
wherein the synthetic board stock has a density less than 1.0 g/cm³.

2. The synthetic board stock of claim 1, wherein:
the outer layer is at least partially comprised of polypropylene.

3. The synthetic board stock of claim 1, wherein:
the center layer is at least partially comprised of polypropylene resins.

4. The synthetic board stock of claim 1, wherein:
the inner layer is at least partially comprised of a blend of polypropylene resins.

5. The synthetic board stock of claim 2, wherein:
the outer layer is at least partially comprised of an inorganic filler.

6. The synthetic board stock of claim 3, wherein:
the center layer is at least partially comprised of a hydrocarbon resin.

7. The synthetic board stock of claim 4, wherein:
the inner layer is a least partially comprised of an antistatic additive.

8. The synthetic board stock of claim 1, wherein:
the outer layer is at least partially comprised of polypropylene.
the center layer is at least partially comprised of polypropylene resins.
the inner layer is at least partially comprised of a blend of polypropylene resins;
the outer layer is at least partially comprised of an inorganic filler.
the center layer is at least partially comprised of a hydrocarbon resin.
the inner layer is a least partially comprised of an antistatic additive.

9. The synthetic board stock of claim 8, wherein:
the synthetic board stock is configured to be made via a cast film multilayer coextrusion process.

10. A process for producing a synthetic board stock for packaging food, comprising the steps of:
making an outer layer;
making a center layer differentiable from the outer layer;
coextruding the outer layer and the center layer;
wherein the synthetic board stock has a density less than 1.0 g/cm³.

11. The process of claim 10, further comprising:
making an inner layer.

12. The process of claim 11, further comprising the steps of:
gravimetrically weighing the raw materials of the outer layer, the center layer and the inner layer.

13. The process of claim 12, further comprising the steps of:
vacuum conveying the raw materials of the outer layer to a first of three independent single screw extruders.

14. The process of claim 11, further comprising the steps of:
vacuum conveying the raw materials of the center layer to a second of three independent single screw extruders.

15. The process of claim 11, further comprising the steps of:
vacuum conveying the raw materials of the inner layer to a third of three independent single screw extruders.
